(19) United States
(12) Patent Application Publication
(10) Pub. No.: US 2005/0036870 A1
(43) Pub. Date: Feb. 17, 2005

(54) Loading and transporting system

(76) Inventor: Scott Johansen, Simi Valley, CA (US)

Correspondence Address: GANZ LAW, P.C., P O BOX 2200, HILLSBORO, OR, 97123, US

(21) Appl. No.: 10/911,818

(22) Filed: Aug. 4, 2004

Related U.S. Application Data
(60) Provisional application No. 60/493,315, filed on Aug. 6, 2003.

(51) Int. Cl. B60P 9/00

(52) U.S. Cl. 414/538

(57) ABSTRACT

A loading and transporting system for a motorcycle the includes a carrier mounted in a transporting vehicle and a ramp removably attached to the carrier, the ramp having an arched shape to prevent motorcycles having a low ground clearance from “bottoming out.” The carrier includes guide rails attached to the vehicle to allow the motorcycle to sit relatively low in the vehicle. Struts made of strong tubing are also provided to stabilize the motorcycle during transportation.

This invention claims the benefit of co-pending U.S. Provisional Application No. 60/493,315, entitled “Loading and Transporting System”, filed Aug. 6, 2003, the entire disclosure of which is hereby incorporated by reference as if set forth in its entirety for all purposes.

### BACKGROUND OF THE INVENTION

This invention is directed to a loading and transporting system and, more particularly, to a modular rail and motorized trolley system for loading and transporting personal recreational vehicles such as motorcycles.

The popularity of personal recreation vehicles such as motorcycles has increased over the years. Many users of such personal recreation vehicles wish to transport the vehicle to remote locations or to carry such vehicles for use during a vacation away from home. There is a need for a system to load, transport, and unload such a vehicle into and out of a transportation vehicle such as a van, truck, motor home, or other automobile.

Various systems do exist for this purpose. However, such systems are limited by their difficultly of use and/or assembly. For example, many such systems utilize a ramp to assist loading and unloading motorcycles and other craft into and out of an automobile. However, motorcycles or crafts having a low ground clearance cannot be easily loaded and unloaded because the ramp configuration causes the motorcycle to “bottom out.” Additionally, current systems are not compact and, because of the construction of the system that secures the motorcycle during travel, the motorcycle takes up a large amount of space or headroom in the automobile. Furthermore, current systems use various types of securing devices such as straps to fasten and secure the motorcycle during travel. However, such securing devices are difficult to use and often require many adjustments in order to secure the motorcycle.

Another disadvantage of current systems is that they are typically made of relatively thick steel members and require many parts, which increases the size, weight, and expense of the system. Furthermore, such systems are typically difficult to assemble and store when not in use.

### SUMMARY OF THE INVENTION

The present invention overcomes the problems of current systems by providing a loading and transporting system for motorcycles that allows loading and unloading of motorcycles having low ground clearance, that is compact and utilizes less headroom in the automobile, and that utilizes unique struts to secure and stabilize the motorcycle during travel. The present invention additionally provides a loading and transporting system that is lightweight and is easy to install and assemble.

This invention provides an improved loading and transporting system for safe loading and transportation of motorcycles inside of or upon land-based motor vehicles. The loading and transportation system preferably includes mechanisms and devices for raising the motorcycle, installing the motorcycle, stabilizing the motorcycle, and enabling movement of the motorcycle. A loading ramp for raising the motorcycle onto the motor vehicle is preferably arched in profile and is preferably made of rigid material such as metal. It is preferably an integral unit and directs the travel of a loading trolley and directs the travel of the motorcycle rear wheel. The ramp removably connects to a carrier secured to the bed of the motor vehicle. The carrier is preferably straight in profile and is made of a rigid material such as metal. The carrier is an integral unit and directs the travel of the trolley and also directs the travel of the motorcycle rear wheel. The ramp and carrier are connected together with a connection that is easy to connect and disconnect. A winch is mounted to the carrier and connects to the trolley to load and unload the motorcycle. The trolley immobilizes the front wheel of the motorcycle and vertically braces the motorcycle during transport. The trolley rigidifies the entire unit and interfaces with both the ramp and carrier during loading and transport of the motorcycle. The trolley preferably includes low friction rollers or bushings made of plastic or rubber that interface with the ramp and carrier. The winch preferably contains a power driven cargo-conveying device that connects to the trolley. The winch preferably includes a forward and reverse selectable power interface.

The loading and transporting system is operated by first connecting the carrier into or upon the transporting vehicle by use of mounting machine bolts inserted through holes in the carrier and holes drilled through the transporting vehicle. The forward and reverse selectable power interface of the winch is then connected to the power source of the vehicle by hardwire. The trolley is then inserted into the carrier and connected to the power driven cargo-conveying device of the winch. The ramp is then connected to the carrier. The forward and reverse selectable power interface of the winch is then set to reverse and engaged until the trolley has come to rest at the bottom of the ramp. The motorcycle is now positioned in such a manner as to orient it with the front wheel directed towards the trolley and is then moved forward until the front wheel becomes entrapped in the trolley. The motorcycle may then be attached to the trolley by a retaining device, which connects to the front axel of the motorcycle and to the trolley. Two additional retaining devices are attached to each side of the motorcycle on one end and to the trolley on the other end. Once the motorcycle has been securely attached to the trolley the forward and reverse selectable interface of the winch is then set to forward and engaged. The movement of the trolley then conveys the motorcycle from the ramp onto the carrier. Movement is terminated when the trolley contacts the forward and reverse selectable interface of the winch. The ramp is then disconnected and placed in the transporting vehicle. The motorcycle is then secured to the transporting vehicle with tie-downs as necessary for safe transport.

These and other embodiments are described in more detail in the following detailed description and figures.

The foregoing is not intended to be a limiting description of the invention as persons skilled in the art are capable of appreciating other embodiments and features for the following detailed description in conjunction with the drawings.

### BRIEF DESCRIPTION OF THE DRAWINGS

FIG. 1 is a side view of the loading and transporting system mounted to a motor vehicle shown in phantom.

FIG. 2 is a top view of the system as shown in FIG. 1.

FIG. 3 is a top view of the ramp.

FIG. 4 is a side view of FIG. 3.

FIG. 5 is a sectional view taken along line 5-5 in FIG. 3.

FIG. 6 is a top view of the carrier.

FIG. 7 is a sectional view taken along line 7-7 in FIG. 6.

FIG. 8 is a top view of the trolley.

FIG. 9 is a rear end view of the trolley.

FIG. 10 is a side view of the assembly shown in FIG. 9.

FIG. 11 is an isometric view of the trolley and carrier assembly.

FIG. 12 is a rear end view of the trolley and carrier assembly with the winch.

FIG. 13 is a view of one of the struts forming the strut retainer system.

FIG. 14 is a side view of an alternative embodiment of the ramp.

FIG. 15 is an enlarged partial view of the hinge of the ramp of FIG. 14.

FIG. 16 is an enlarged partial top view of the hinge of FIG. 15.

FIG. 17 is a top view of another embodiment of the trolley.

FIG. 18 is a rear view of the embodiment of FIG. 17.

FIG. 19 is a side view of the embodiment of FIG. 17.

FIG. 20 is a view showing a cross section of a preferred embodiment of the carrier and trolley.

FIG. 21 is a side view of a preferred embodiment of the ramp.

FIG. 22 is a cross section of the ramp of FIG. 21.

FIG. 23 is a partial enlarged assembly of the ramp and carrier of FIGS. 20 and 21.

### DETAILED DESCRIPTION OF THE INVENTION

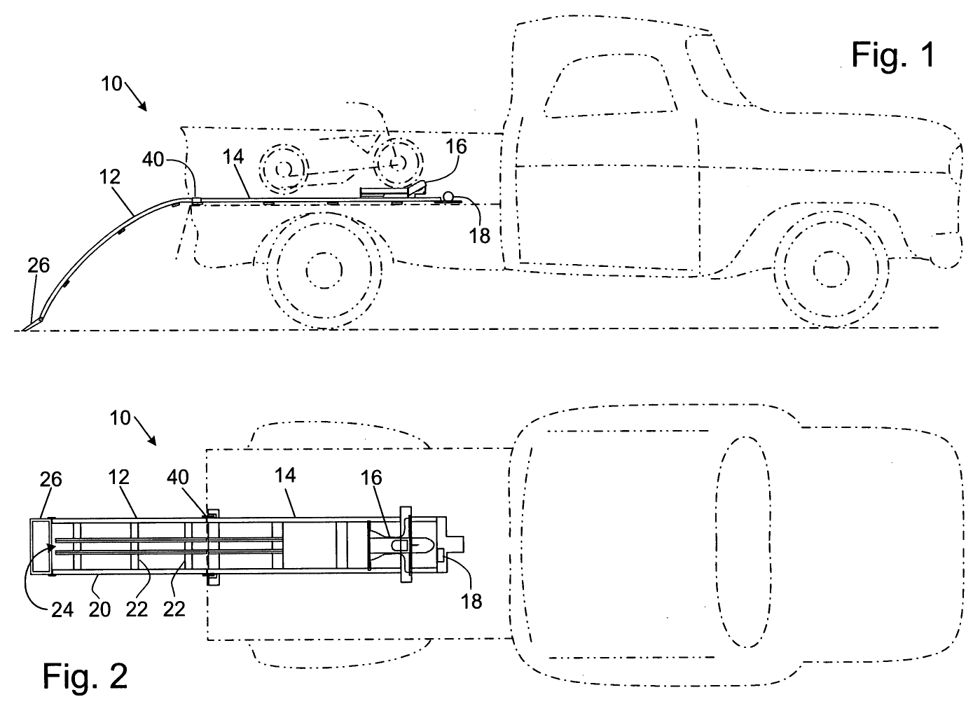

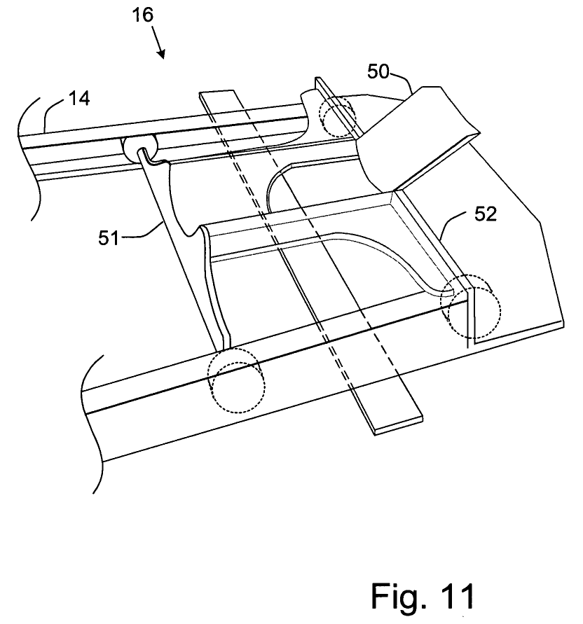

FIGS. 1-13 show a first embodiment of the loading and transporting system 10 of the present, which includes a ramp 12 for loading/unloading a motorcycle to and from an automobile (shown in phantom), a carrier 14 secured to the bed of the automobile for carrying the motorcycle during transport, a trolley 16 onto which the motorcycle is secured for moving the motorcycle along the ramp 12 and carrier 14, and a winch 18 attached to carrier 14 and connected to the power system of the automobile for pulling trolley 16 along the ramp 12 and carrier 14. The entire system may be made of a lightweight metal such as aluminum and may be heat-treated for strength. However, the invention is not limited to aluminum and may be made of other suitable materials.

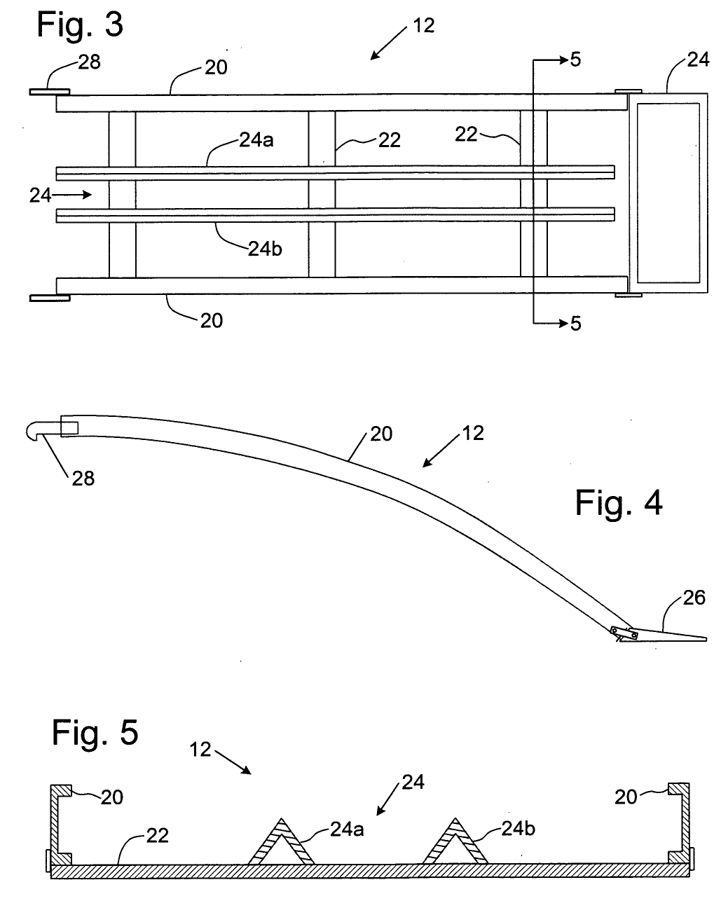

Ramp 12 includes two opposed arched guide rails 20 connected such as by welding to plural cross members 22. In this embodiment guide rails 20 are preferably made of aluminum U-channel. An arched center guide channel 24 is formed by spaced members 24a and 24b (FIGS. 3 and 5) to guide the motorcycle wheels. Members 24a and 24b are connected such as by welding to cross members 22. A base plate 26 is hinged to one end of ramp 12 to assist loading the motorcycle onto ramp 12. Ramp 12 includes a pair of hook-shaped bayonet mounts 28 (FIGS. 3 and 4) at one end for connection with carrier 14.

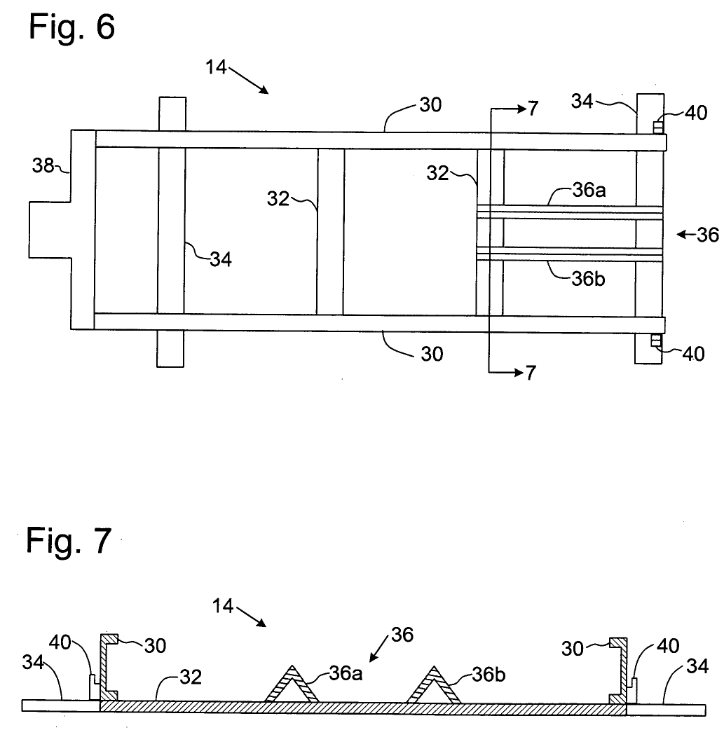

Carrier 14 of this embodiment, shown best in FIGS. 6 and 7, is preferably formed of opposed straight U-channel guide rails 30 interconnected such as by welding to plural cross members 32. Mounting members 34 are similarly connected to guide rails 30 for mounting carrier 14 to the bed of an automobile. Carrier 14 may be mounted into or onto the transporting vehicle or automobile by bolts (not shown) extending through mounting members 34 and into the bed of the transporting vehicle. A U-shaped center guide channel member 36 is located between guide rails 30 and is formed by opposed members 36a and 36b welded or otherwise secured to a cross member 32 and a mounting member 34 to guide the wheels of the motorcycle during loading and locate the rear motorcycle wheel during transport. A winch mounting plate 38 is welded or otherwise connected to one end of carrier 14 to provide support for mounting winch 18. Slotted bayonet mount receivers 40 are provided at the other end of carrier 14 for connection with bayonet mounts 28 on ramp 12.

Trolley 16 is preferably formed of a pair frame gussets 42 connected between a front axel 44 and a rear axel 46. Front axel 44 and rear axel 46 each include a pair of guide bushings or rollers 48 made of, for example, nylon, that are slip-fit over the ends of the front and rear axels 44, 46. Guide bushings 48 are inserted into straight guide rails 30 in such a manner as to allow guide bushings 48 to travel inside straight guide rails 30 of carrier 14 and also in arched guide rails 20 of ramp 12. In order to hold the front wheel of the motorcycle a wheel saddle 50 is preferably welded along its sides to frame gussets 42. Wheel saddle 50 has a semi-tubular shape and preferably includes a cutout area 50b and an angle portion 50a to more securely hold the motorcycle front wheel. Wheel saddle 50 is welded at one end to a cargo stabilizer gusset 52, which is welded to front axel 44. At the other end wheel saddle 50 is welded to a rear axel gusset 51 that is welded to rear axel 46. To support angled portion 50a a yoke 54 is welded between angled portion 50a and cargo stabilizer gusset 52. Trolley 16 may also include a wheel retainer strap (not shown) made of any suitable strong and durable material and held in retainer strap slot 56 (FIG. 10). The retainer strap is configured to extend through the front wheel with opposed loose ends tied or otherwise secured together to further hold the motorcycle front tire.

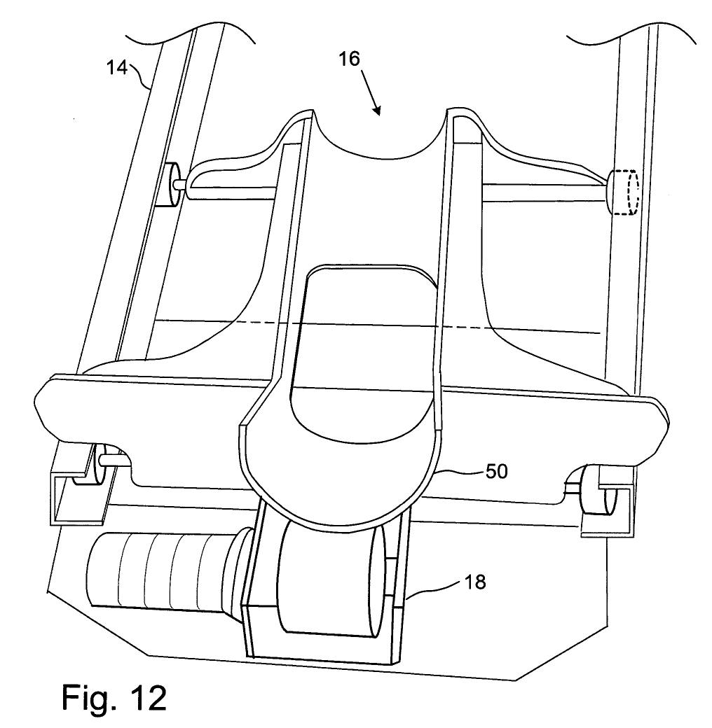

Winch 18, seen most clearly in FIG. 12, may be a commercially available 12-volt motorized strap winch having a two-way control/switch box that is capable of being contacted by trolley 16. Winch 18 is bolted or otherwise mounted to winch mounting plate 36 and is also connected to the power system of the transporting vehicle through the two-way control box/switch. The strap end of winch 18 may be connected to trolley 16 by inserting a metal hook (not shown) into an attachment hole 58 (FIG. 10) in yoke 54.

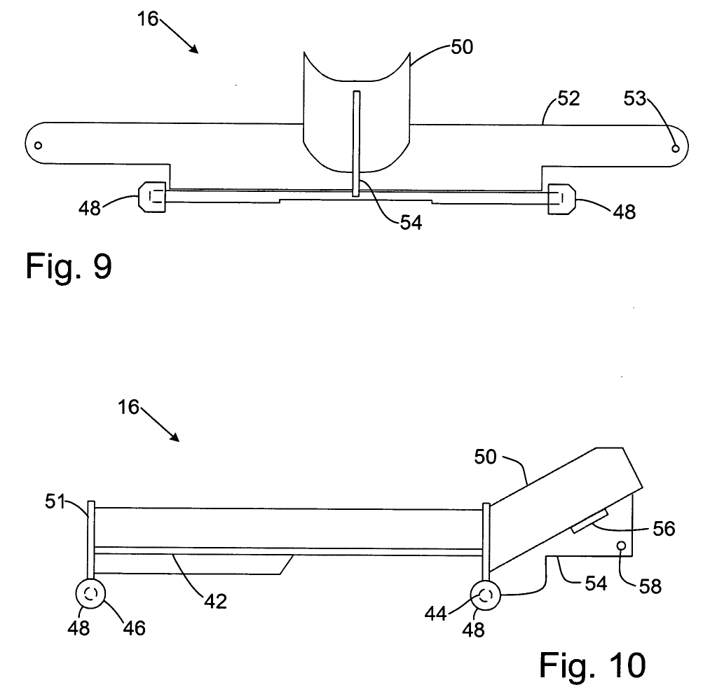

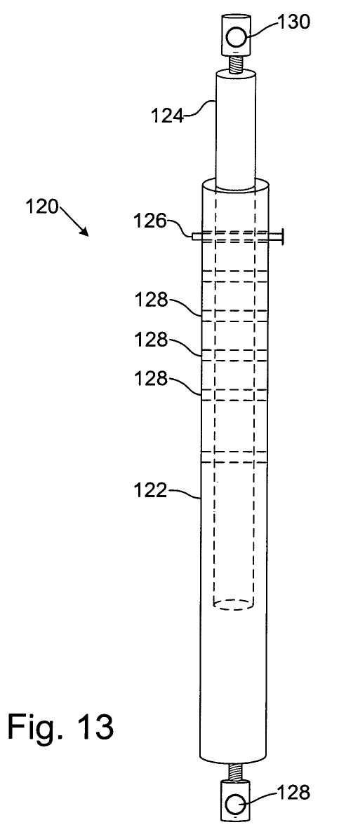

During transport at least two stabilizer struts 120, one of which is shown in FIG. 13, preferably made of metal, such as aluminum, are attached at one end to corresponding mounting holes 53 located in cargo stabilizer gusset 52 (FIG. 9). The other ends of struts 120 are attached to the motorcycle with metal hooks. FIG. 13 shows a strut 120 that is representative of plural struts forming a strut retainer system. Strut 120 includes an external tube 122 and a telescoping internal tube 124. The length of strut 120 may be varied by adjusting internal and external struts 122, 124, and locking them in place by inserting a clevis pin 126 into aligned locking holes 128. Strut 120 is connected to trolley 16 and the motorcycle by commercially available quick release ball joints. For example, strut 120 includes a ball member 129 at the bottom that serves as a male member that snaps into female mounting hole 53 of cargo stabilizer gusset 52. The motorcycle is retrofit with a ball member similar to 129 that serves as a male member that snaps into female opening 130 at the top of strut 120.

When it is desired to load and transport a motorcycle ramp 12 is connected to carrier 14 by interlocking bayonet mounts 28 in bayonet mount receivers 40. The strap of winch 18 is connected to yoke 54. The two-way control/switch box on winch 18 is set to the release mode and winch 18 is engaged so that trolley 16 can be manually guided along carrier 14 and ramp 12 to a stable position on base plate 26. The front wheel of the motorcycle is guided into wheel saddle 50 on trolley 16 and may be held in place by the retainer strap, which, if used, attaches to the front axel of the motorcycle and encircles wheel saddle 50. Struts 120 are attached to cargo stabilizer gusset 52 on trolley 16 and the motorcycle by the quick release ball joints to secure the motorcycle in a vertical position.

The two-way control/switch box on winch 18 is set to the retrieve mode and winch 18 is engaged. As the strap of winch 18 is retrieved trolley 16 travels via arched guide rails 20 of ramp 12 to the point where trolley 16 enters straight guide rails 30 of carrier 14. Concurrently, the rear wheel of the motorcycle travels on ramp 12 via center guide channel 24. Once engaged with straight guide rails 30 trolley 16 continues to travel along carrier 14 until yoke 54 contacts stops (not shown) that may be located on either winch 18 or on winch mounting plate 36. The two-way control/switch box of winch 18 is then manually set to a disengage position. The motorcycle may then be secured to the transporting vehicle by standard tie-downs, as necessary. Ramp 12 is then disengaged from carrier 14 and may be stored in the transporting vehicle for later use.

To unload the motorcycle, ramp 12 is again attached to carrier 14 through bayonet mounts 28 and bayonet mount receivers 40. Base plate 36 is then attached to the opposite end of ramp 12. The standard tie-downs, if used, are then removed and the two-way control/switch box is set to the release mode. Winch 18 is then engaged so that trolley 16 is manually guided along straight guide rails 30 of carrier 14 and arched guide rails 20 of ramp 12 until the motorcycles reach base plate 36. The two-way control/switch box of winch 18 is then disengaged. Stabilizer struts 120 are then removed from the motorcycle. If used, the retainer strap is then removed and the front wheel of the motorcycle is removed from wheel saddle 50. The two-way control/switch box of winch 18 is once again set to the retrieve mode and winch 18 is engaged to pull trolley 16 up ramp 12 and along carrier 14 until yoke 54 contacts winch mounting plate 36. Ramp 12 and base plate 36 are then disengaged from carrier 14.

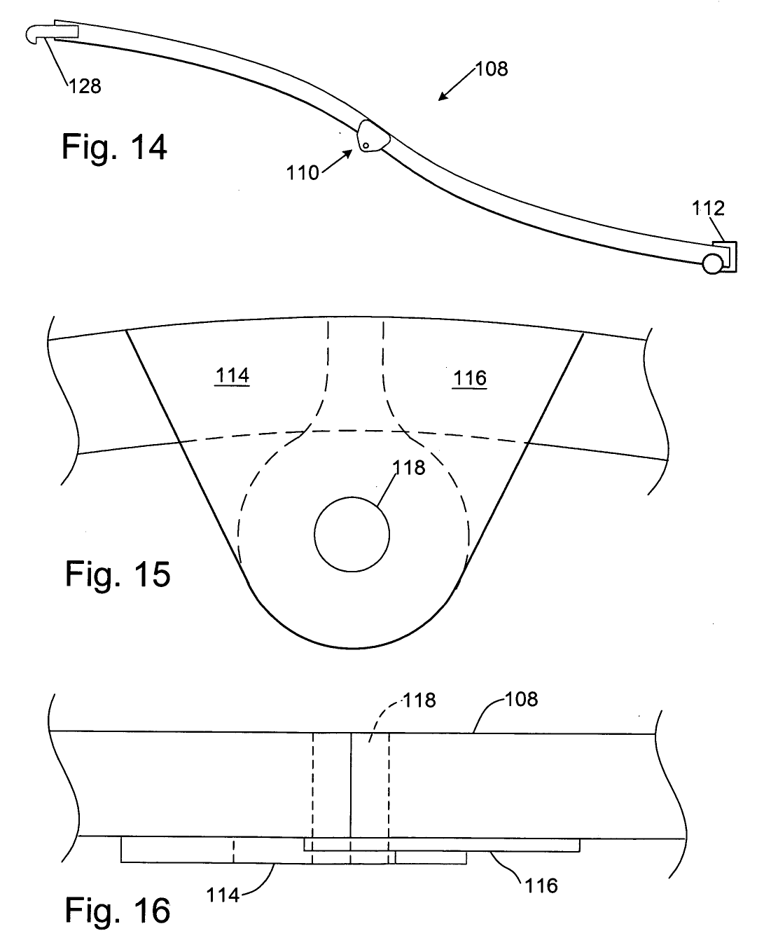

FIGS. 14-16 show another embodiment of a ramp in the form of a folding ramp 108. As seen in FIG. 14, ramp 108 is arched and has a substantially S-shape with an interlocking hinge 110 about which ramp 108 may be folded. Ramp 108 may also include cap ends 112 that serve as stop rollers for the trolley. Preferably, ramp 108 uses aluminum diamond plate stress panel for structure and tire surface. Hinge 110 may be formed of interlocking members 114 and 116 that may be welded to sides of ramp 108 and interconnected by a hinge pin 118.

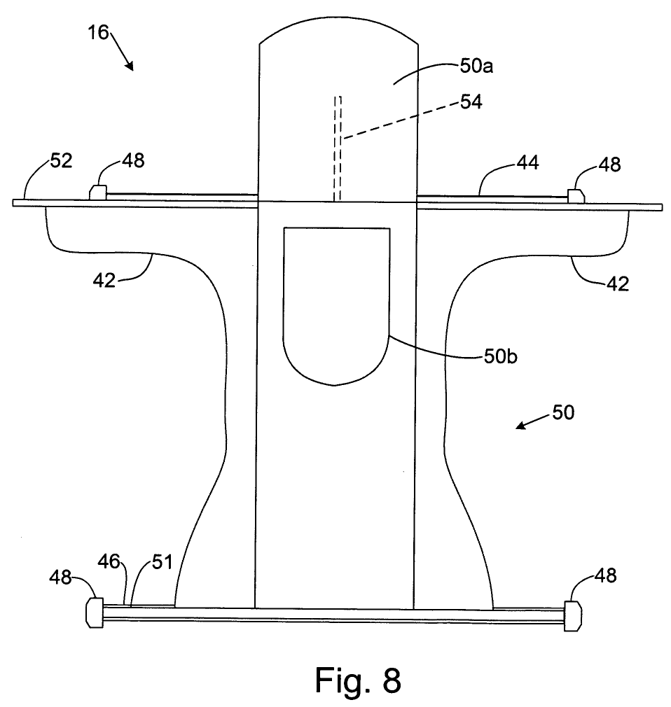

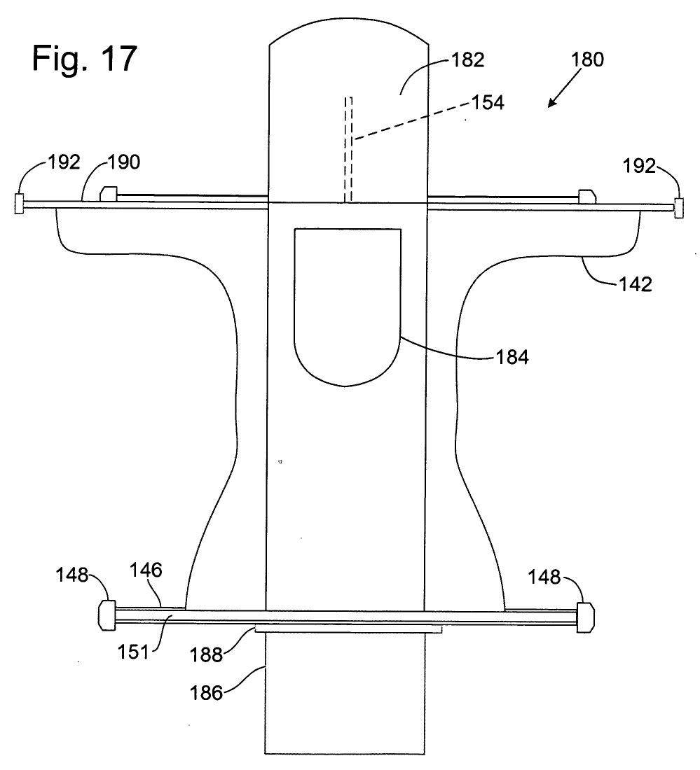

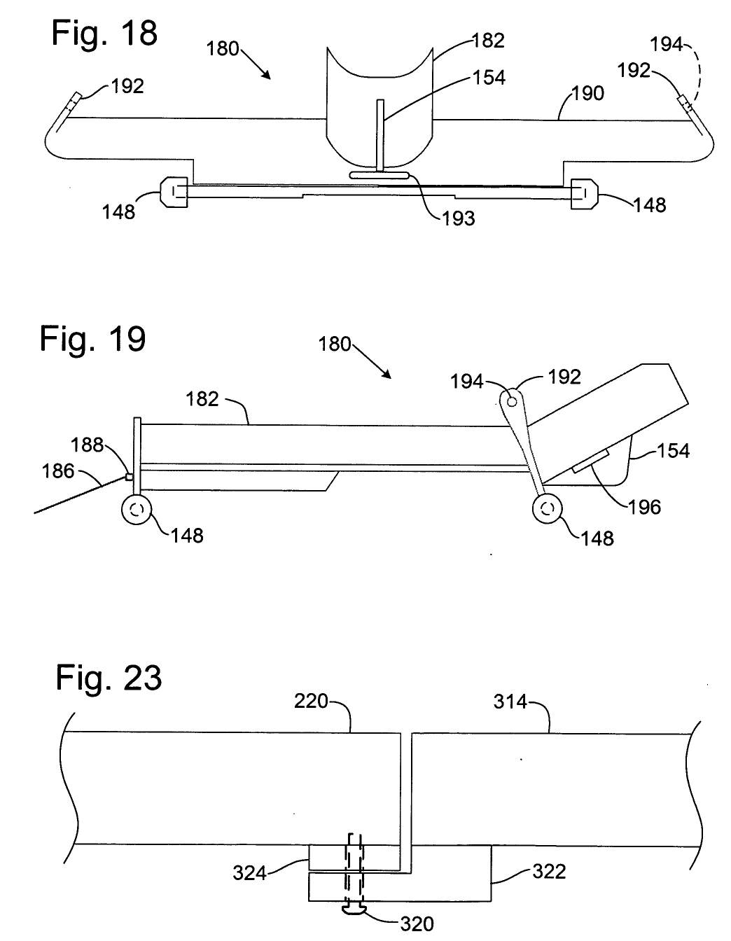

FIGS. 17-19 show an alternative trolley 180 that includes a wheel saddle 182 with a cutout 184 that receives the front wheel of the motorcycle. A drop down entry ramp 186 is connected to trolley 180 through a friction hinge 188. Cargo stabilizer gusset 190 includes strut mounts 192 with holes 194 that connect to struts 120 through the quick release ball joint in the manner described above. A strap mount 193 (FIG. 18) for connection to the strap of winch 18 is provided at one end of trolley 180 and retainer strap holder 196 may be provided on trolley 180 to further secure the motorcycle, if desired. Trolley 180 is otherwise constructed substantially similar to the embodiment of trolley 16 (FIG. 8) including frame gussets 142, rear axle 146, guide bushings 148, and rear axle gusset 151.

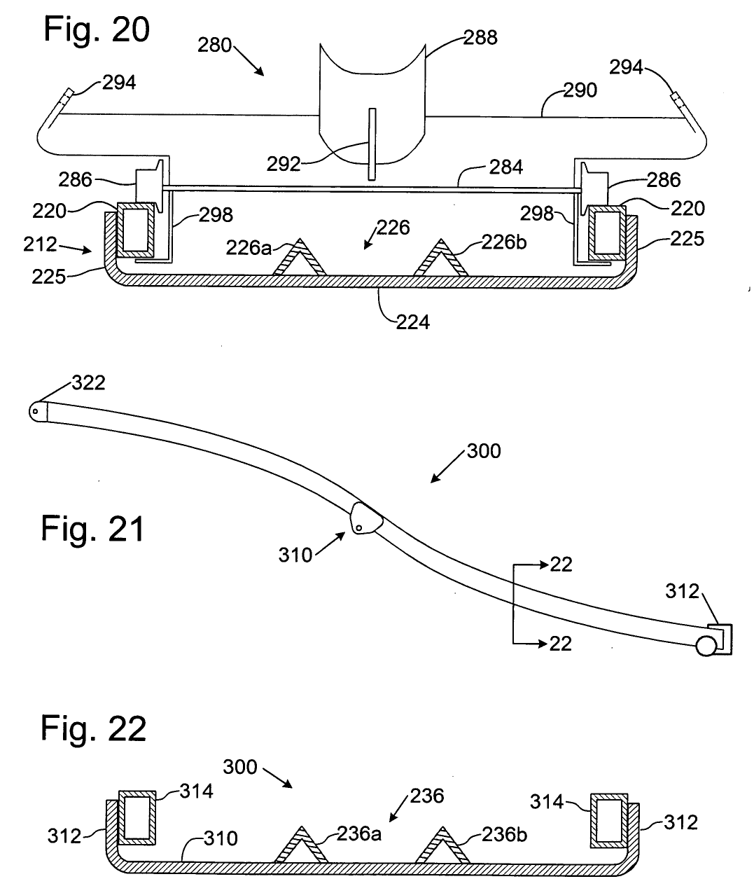

FIGS. 20-22 show a preferred embodiment of a ramp 208, a carrier 224, and a trolley 180. Carrier 212 includes rails 220 that are preferably formed of metal rectangular tubes. Carrier 212 includes mounting members 224 similar to mounting members 34 of FIG. 6. Mounting members 224 include upturned sides 225 to which rails 220 are welded or otherwise secured on the inside thereof. Additionally, carrier 212 may include cross members (not shown) similar to cross members 32 of FIG. 6, which may include upturned sides to which rails 220 are welded or otherwise secured. Carrier 212 includes a guide channel 226 formed by spaced channel members 226a and 226b for guiding the wheels of the motorcycle in the manner described above with respect to the embodiment of FIG. 6. Trolley 280 is constructed substantially similar to the previous trolley embodiments including a front axle (not shown), rear axle 284, roller or guide bushings 286, wheel saddle 288, frame gussets (not shown), cargo stabilizer gussets, one of which is shown at 290, yoke 292, and strut mounts 294. Trolley 280 may also include other features not shown, such as a retainer strap slot and an attachment hole for the winch strap. Trolley 280 includes anti-lift members 298 that are welded or otherwise secured to trolley 280 to extend between rails 220 and mounting members 224 as guide bushings 286 ride on top of rails 220. Anti-lift members 298 are spaced from the bottom of rails 220 so as not to interfere with the movement of trolley 280.

As seen in FIGS. 21 and 22, ramp 300 is arched in a substantially S-shaped configuration having a hinge 310 for folding in a manner described with reference to the embodiment of FIG. 14. Ramp 300 may include end caps 312 to act as a stop for trolley 280. As seen most clearly in FIG. 22, ramp 300 is constructed in a manner similar to carrier 212. Ramp 300 includes cross members 310 having upturned sides 312 to which rails 314 are welded or otherwise secured so that trolley 280 moves along ramp 300 in the manner similar to which trolley 280 moves along carrier 226. As seen in FIG. 23, ramp 300 connects to carrier 226 through a release pin hinge connection in which a release pin 320 extends through hole in member 322 welded or otherwise secured to rail 314 of ramp 300 and through hole in member 324 welded or otherwise secured to rail 220 of carrier 226.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

1. A loading and transporting system comprising,
a carrier constructed and arranged to be connected to a transporting vehicle for transporting a personal craft;
a ramp removably connected to the carrier along which the personal craft travels from the ground to the carrier, the ramp having an arched shape, and
a trolley movable along the ramp and carrier for loading and unloading the personal craft.

2. The loading and transporting system of claim 1, wherein the carrier includes guide rails along which the trolley travels and constructed and arranged so that the personal craft sits relatively low in the transporting vehicle.

3. The loading and transporting system of claim 2, wherein the guide rails are made of U-channel.

4. The loading and transporting system of claim 2, wherein the guide rails have a substantially C-shaped cross-section.

5. The loading and transporting system of claim 1, further comprising struts for connection with the personal craft to stabilize the personal craft during transportation.

6. The loading and transporting system of claim 5, wherein the struts include telescoping first and second tubes with pin holes into which a pin is inserted to lock the first and second tubes in place.

7. The loading and transporting system of claim 1, wherein the personal craft is a motorcycle.

8. The loading and transporting system of claim 1, wherein the ramp has a substantially S-shape.

9. The loading and transporting system of claim 1, wherein the ramp includes a hinge to allow the ramp to be folded.

10. A loading and transporting system comprising,
a carrier constructed and arranged to be connected to a transporting vehicle for transporting a personal craft;
a ramp removably connected to the carrier along which the personal craft travels from the ground to the carrier, the ramp having a ground clearance that allows loading of the craft having low ground clearance, and
a trolley movable along the ramp and carrier to load and unload the craft.

11. The system of claim 10, wherein the carrier includes a power mechanism adapted for connection with the trolley to move the trolley along the rail and carrier.

12. The system of claim 11, wherein the power mechanism is a winch.

13. The system of claim 10, wherein the ramp includes a hinge along its length so that the ramp adapted to be folded about the hinge.

14. The system of claim 10, further comprising a base plate hinged to the ramp.

15. The system of claim 1, in which the carrier includes plural members extending between rails, the rails being connected to the plural members in a manner to define a space between the rails and the plural members.

16. The system of claim 15, in which the trolley includes at least one anti-lift device extending into the space between the rails and the plural members.

17. The system of claim 1, in which the ramp includes plural members extending between rails, the rails being connected to the plural members in a manner to define a space between the rails and the plural members.

18. The system of claim 15, in which the trolley includes at least one anti-lift device extending into the space between the rails and the plural members.

19. The system of claim 1, wherein the carrier and the ramp include rails having a substantially rectangular tubular shape.

20. The system of claim 1, wherein the ramp is connected to the carrier through a release pin connection.
